(19) United States
(12) Patent Application Publication
(10) Pub. No.: US 2012/0012076 A1
(43) Pub. Date: Jan. 19, 2012

(54) METHOD OF OPERATING A HYBRID ENGINE

(76) Inventors: David James Atkinson, Berkshire (GB); Peter Stuart Brett, Berkshire (GB); Gordon David Lamb, Berkshire (GB); Anthony David Smith, Wiltshire (GB); Christopher Paul Warrens, Middlesex (GB)

(21) Appl. No.: 12/998,428

(22) PCT Filed: Oct. 12, 2009
(86) PCT No.: PCT/GB2009/002435

§ 371 Date: Apr. 20, 2011

(30) Foreign Application Priority Data
Oct. 20, 2008 (EP) 08253392.8

(51) Int. Cl. F02B 43/00

(52) U.S. Cl. 123/1 A

(57) ABSTRACT

The invention relates to a method of operating a hybrid internal combustion engine, which method comprises: fuelling said hybrid internal combustion engine with a combustible fuel; lubricating said engine with an engine oil composition; and maintaining an oil film thickness of the engine oil composition in the big end conrod bearing shells of the engine of at least 0.4 μm; in which the temperature of the engine oil composition is maintained below 123° C. and the engine oil composition has: a high temperature, high shear viscosity of less than 2.6 cP (2.6 millipascal second) at 150° C. and at a shear rate of 10⁶ s⁻¹; a Noack volatility of at most 13 weight %; and comprises: (A) a base oil which is at least one synthetic basestock, the base oil having a kinematic viscosity of at least 2.0 cSt (2.0 mm2/s) at 100 ° C.; and (B) an additive package which comprises at least one dispersant, at least one detergent, and at least one phosphorus-containing, anti-wear additive in an amount to provide a total concentration of phosphorus-containing, anti-wear additives in the engine oil composition corresponding to 0.01 to 0.2 weight % phosphorus in the engine oil composition.

This invention relates to a method of operating a hybrid internal combustion engine.

Hybrid internal combustion engines are used with one or more other sources of power in hybrid vehicles. Typically, a hybrid vehicle combines mechanical and electrical power sources, the mechanical power source being provided by an internal combustion engine. The hybrid internal combustion engine may be a spark ignition internal combustion engine or a compression ignition internal combustion engine.

Hybrid internal combustion engines may be used in a vehicle in series or in parallel with other power sources such as one or more of electric motors, hydraulic motors, inertia devices (for example flywheels) and the like.

When used in series, the internal combustion engine powers an electrical generator and is not mechanically connected to the drive-train. Electricity from the generator is fed to one or more motors that move the vehicle, and excess energy can be used to charge batteries. Further, the internal combustion engine may be switched off when it is not required, or when it is inefficient for it to be operated, for example, when the vehicle is idling. When large amounts of power are required, electricity comes from both the batteries and the engine-generator section.

When used in parallel, the internal combustion engine and an electric motor may be mechanically connected to the mechanical transmission. In many cases, the internal combustion engine is the dominant power source and is used for primary power, with the electric motor turning on only when a boost is needed. Other systems can operate with just the electric motor or internal combustion engine operating alone. Many systems combine an electrical generator and an electrical motor into one unit, and this device may also replace the starter motor used to get the internal combustion engine to turn over.

In another type of parallel system, the internal combustion engine drives the wheels directly, with the electric motor serving as a power assist when extra power is needed, and to recapture kinetic energy, usually lost during braking.

Low viscosity lubricating oils for internal combustion engines are known for providing fuel efficiency. Thus, SAE Technical Paper 2004-01-1936 entitled “Possibilities of Ultra Low Viscosity Fuel Saving Gasoline Engine Oil” by Tamoto et al June 2004 relates to gasoline engine friction tests which were conducted using ultra low viscosity engine oils. An oil containing mineral base oil stock showed an increase in viscosity, increase in oil consumption and deterioration of detergency. An engine oil formulated by a specified synthetic basestock was said to show better performance than the mineral oil. The synthetic base oil ET-1 was said to be of an ether type, having a low viscosity and high aniline point similar to the mineral oil but with a high viscosity index. The viscosity of the synthetic base oil was stated to be 2.8 mm²/s at 100° C., but its volatility was not reported. In a formulated oil, MFO-2, the synthetic base was blended with a small amount of Group III 100N mineral base oil for viscosity adjustment and an undefined SL additive package and MoDTC friction modifier were used, in undefined amounts. The HTHS (High Temperature High Shear) viscosity at 100° C. of the formulated oil was stated to be 3.4 mPa·s, its phosphorus content was stated to be 0.10 mass % and the Noack volatility of the formulated oil (250° C., 1 h) was stated to be 14 mass %.

EP-1600495-A relates to an engine oil composition, which is said to have a viscosity lower than the lowest viscosity grade specified by the current standard (Society of Automotive Engineers) viscosity classification and to achieve excellent abrasion resistance under conditions of high temperature and high shear rate without an increase in the amount of anti-abrasion agent. The oil composition is said to be characterised by containing 0.02-0.12 mass % zinc dithiophosphate in a base oil comprised of a mineral oil and/or a synthetic oil, a high-temperature high-shear viscosity at 150° C. and at a shear rate of 1×10⁶ s⁻¹ of less than 2.6 mPa·s and satisfying the equation:

$$\frac{kinematic viscosity at 100 ° C . ( {mm}^{2} \text{/} s )}{\begin{matrix}high \text{-} temperature high \text{-} shear viscosity at 100 ° C . and \\ shear rate 1 \times {10}^{6} {s}^{- 1} ( mPa \cdot s )\end{matrix}} \leq 1.3$$

According to EP-1600495-A, an ordinary base oil for lubricating oil can be used for the engine oil composition, there being no special limitation and examples are said to include mineral type base oil, GTL (gas to liquid) type base oil, synthetic oil type base oil or their mixture. According to EP-1600495-A, one characteristic property required for the engine oil composition is that the evaporability should be minimized. Evaporation is said to depend upon the light oil component and if a mineral oil is used, when the viscosity of the base oil is to be reduced, it is said that it is inevitable that the evaporability will increase. It is further stated that it is necessary to keep the NOACK evaporability down to 15 mass % or lower. It is stated that it is preferred to select a proper base oil with low viscosity and a low NOACK evaporability, for example, the ester described therein, corresponding to the amount the viscosity of the base oil is to be reduced. According to EP-1600495-A, the base oil is manufactured using various types of base oils or by properly mixing two or more types of base oils in order to realize the desired viscosity characteristic, NOACK evaporability, and other properties. The 100° C. kinematic viscosity of the base oil prepared in this way is said to be adjusted within the range 2-40 mm²/s, preferably, within the range of 2-20 mm²/s, or more preferably, 3-8 mm²/s.

The minimum oil film thickness of an engine oil composition required for acceptable operation of an internal combustion engine is considered to be 0.4 μm in the big end conrod (connecting rod) bearing shells. In an automotive internal combustion engine a conrod connects each piston to the crankshaft. The big end of the conrod is connected to the crankshaft via the big end bearing shell. In automotive internal combustion engines the big end conrod bearing shells are considered to be of the most critical bearings for wear. The minimum oil film thickness of a lubricating oil composition is primarily dependent on the viscosity of the oil and the temperature of the oil. For example, the Applicant has found that, in a modern light duty diesel engine, for an oil having a high temperature, high shear viscosity of less than 2.6 cP at 150° C. and at a shear rate of 10⁶ s⁻¹, the oil must be maintained at a temperature of less 123° C. in order to maintain a minimum oil film thickness of 0.4 μm in the big end conrod bearing shells.

At severe operating conditions, for example, prolonged operation in urban traffic conditions and/or high speed motorway driving, the engine oil in an internal combustion engine can reach very high temperatures. For example, in conventional gasoline and diesel internal combustion engines, the engine oil may reach temperatures of up to 140° C. at severe operating conditions.

In engines lubricated with a low viscosity engine oil, such as the oil described in EP-1600495-A, it would be expected that, under severe operating conditions, the oil would become too thin to maintain an oil film thickness of at least 0.4 μm in the big end conrod bearing shells, which may result in inadequate lubrication. Inadequate lubrication may result in a number of disadvantages, for example, bearing failure, excessive cylinder or liner wear, increased oil consumption and potential engine failure.

Thus, the risk of the oil's minimum oil film thickness falling below an acceptable level may prevent the use of low viscosity oils in engines in which the oil may be exposed to high temperatures.

Thus, there remains a need for a means of employing such engine oil compositions in which the engine oil is prevented from reaching temperatures which would cause the oil film thickness of the engine oil in the big end conrod bearing shells to fall below 0.4 μm.

It has now been found that such oils may be usefully employed in hybrid internal combustion engines.

Thus, according to the present invention there is provided a method of operating a hybrid internal combustion engine, which method comprises:
fuelling said hybrid internal combustion engine with a combustible fuel;
lubricating said engine with an engine oil composition; and
maintaining an oil film thickness of the engine oil composition in the big end conrod bearing shells of the engine of at least 0.4 μm;
   in which the temperature of the engine oil composition is maintained below 123° C. and the engine oil composition has:
a high temperature, high shear viscosity of less than 2.6 cP (2.6 millipascal second) at 150° C. and at a shear rate of 10⁶ s⁻¹;
a Noack volatility of at most 13 weight %;
   and comprises:
(A) a base oil which is at least one synthetic basestock, the base oil having a kinematic viscosity of at least 2.0 cSt (2.0 mm²/s) at 100° C.; and
(B) an additive package which comprises at least one dispersant, at least one detergent, and at least one phosphorus-containing, anti-wear additive in an amount to provide a total concentration of phosphorus-containing, anti-wear additives in the engine oil composition corresponding to 0.01 to 0.2 weight % phosphorus in the engine oil composition.

The present invention allows useful employment of low viscosity oils, as defined, since periods of hybrid vehicle operation where the hybrid internal combustion engine is switched off, or where the internal combustion engine is assisted by power generated by the other power source can prevent the engine oil reaching temperatures which would cause the minimum oil film thickness to fall below 0.4 μm. Such employment of the defined low viscosity oils allows exploitation of the fuel economy benefits of low viscosity oils, whilst maintaining adequate lubrication in the engine.

The present invention further provides for the use of an engine oil composition having a high temperature, high shear viscosity of less than 2.6 cP (2.6 millipascal second) at 150° C. and at a shear rate of 10⁶ s⁻¹, and a Noack volatility of at most 13 weight %; and comprising (A) a base oil which is at least one synthetic basestock, the base oil having a kinematic viscosity of at least 2.0 cSt (2.0 mm²/s) at 100° C., and (B) an additive package which comprises at least one dispersant, at least one detergent, and at least one phosphorus-containing, anti-wear additive in an amount to provide a total concentration of phosphorus-containing, anti-wear additives in the engine oil composition corresponding to 0.01 to 0.2 weight % phosphorus in the engine oil composition in a hybrid internal combustion engine to provide an oil film thickness in the big end conrod bearing shells of the engine of at least 0.4 μm.

### The Engine Oil

The engine oil composition employed in the method of the present invention has a high temperature, high shear viscosity of less than 2.6 cP (2.6 millipascal second) at 150° C. and at a shear rate of 10⁶ s⁻¹; and a Noack volatility of at most 13 weight %.

The high temperature, high shear viscosity of the engine oil employed in the method of the present invention is measured using a high temperature, high shear viscometer at 150° C. and at a shear rate of 10⁶ s⁻¹. The high temperature, high shear viscosity of the engine oil may be measured according to the method CEC L-36-A-97 or ASTM D4683.

The Noack volatility of the engine oil may be measured according to the CEC-L-40-A-93 method.

The engine oil may exhibit Newtonian or non-Newtonian behaviour. The engine oil of the present invention may be an SAE grade 0W, 5W, 10W, 0W20, 5W20 or 10W20 oil.

### The Base Oil

The base oil has a kinematic viscosity of at least 2.0 cSt (2.0 mm²/s) at 100° C.

The kinematic viscosity of the base oil may be measured according to the ASTM D445 method.

The base oil is at least one synthetic basestock. Synthetic base stocks may be selected from the group consisting of:
(i) Group III basestocks. Group III basestocks are defined according to API standard 1509, “ENGINE OIL LICENSING AND CERTIFICATION SYSTEM”, November 2004 version 15th edition Appendix E, which defines basestocks which are used for base oils as belonging to one of five Groups as set out in Table I below. Group III basestocks are synthetic basestocks in the present invention not least because they are subjected to extensive processing in their manufacture.

TABLE I

| | Saturated | | Sulphur | | |
|---|---|---|---|---|---|
| | hydrocarbon content | | content | | |
| Group | (wt %) | | (wt %) | | Viscosity Index |
| I | <90 | and/or | >0.03 | and | ≧80 and <120 |
| II | ≧90 | and | ≦0.03 | and | ≧80 and <120 |
| III | ≧90 | and | ≦0.03 | and | ≧120 |

| | |
|---|---|
| IV | polyalpha olefins |
| V | all basestocks not in Groups I, II, III or IV |

(ii) esters, for example (a) polyol esters for example, those available from Uniqema designated Priolube 3970 (Trade mark) Hatco designated H-2925 (Trade Mark); (b) esters of dibasic acids (for example, phthalic acid, succinic acid, alkyl succinic acid, alkenyl succinic acid, maleic acid, azelaic acid, suberic acid, sebacic acid, fumaric acid, adipic acid, linoleic acid dimer and the like), with alcohols, (for example, butyl alcohol, hexyl alcohol, 2-ethyl hexyl alcohol, isodecyl alcohol, dodecyl alcohol, tridecyl alcohol, ethylene glycol, diethylene glycol monoethers, propylene glycol and the like); (c) esters of C₅₋₁₈ monocarboxylic acids and polyols (for example, neopentyl glycol, trimethylolpropane, pentaerythritol, dipentaerythritol, tripentaerythritol etc.);
(iii) basestock derived from a gas to liquids (GTL) process. Basestock from a GTL process may comprise the lubricating oil fraction separated from the liquid reaction product obtained using gas, including natural gas, as a raw material in a GTL process and/or the lubricating oil fraction obtained by hydrogenation then isomerisation of wax generated in a GTL process;
(iv) basestocks derived from a pyrolysis process. Basestock from a pyrolysis process may comprise the lubricating oil fraction obtained by hydrogenation then isomerisation of wax generated in a pyrolysis process;
(v) basestocks derived from an asphalt to liquids (ATL) process. Basestock from an ATL process may comprise the lubricating oil fraction obtained by hydrogenation then isomerisation of wax generated in an ATL process;
(vi) poly alpha olefins, for example, polyalphaolefins comprising one or more C₃ to C₃₀ alpha olefin monomers;
(vii) other synthetic basestocks, for example, one or more basestock selected from the group consisting of polybutene, ethylene-alkylene copolymers, alkylbenzenes (for example dodecylbenzene, tetradecylbenzene, di(2-ethylhexyl)benzene, dinonylbenzene and the like), polyphenyls (for example biphenyl, alkylated polyphenyl and the like), alkylated diphenyl ether and alkylated diphenyl sulphide and their derivatives and mixtures thereof;
(viii) and mixtures thereof.

### The Additive Package

The additive package comprises at least one dispersant, at least one detergent, and at least one phosphorus-containing, anti-wear additive in an amount to provide a total concentration of phosphorus-containing, anti-wear additives in the engine oil composition corresponding to 0.01 to 0.2 weight % phosphorus in the engine oil composition.

The additive package may further comprise at least one friction modifier.

Preferably, the additive package further comprises a viscosity modifier.

### The Viscosity Modifier

Where the additive package further comprises at least one viscosity modifier, more than one viscosity modifier may be present in the additive package. The additive package comprises at least one viscosity modifier in an amount to provide a total concentration in the engine oil composition of viscosity modifiers of preferably 0.1 to 10% by weight based upon the engine oil composition. Suitable viscosity modifiers may be non-dispersant types, but are preferably dispersant types.

Suitable non-dispersant viscosity modifiers may be selected from the group consisting of non-dispersible polyalkylmethacrylate; non-dispersant olefin co-polymers for example, polyisobutylene, ethylene-propylene copolymer; non-dispersant star copolymers, for example based upon star hydrogenated isoprene and mixtures thereof. Suitable non-dispersant viscosity modifiers include Lz 7077, available from Lubrizol and SV261, available from Infineum.

Suitable dispersant viscosity modifiers may be selected from the group consisting of dispersible polyalkylmethacrylate; dispersible olefin copolymers; and mixtures thereof. Suitable dispersant viscosity modifiers include Hitec 5777 available from Afton and Viscoplex 6-054 available from Rohmax.

Other suitable viscosity modifiers may be selected from the group consisting of polyallylstyrene; styrene-butadiene hydrogenated copolymer; styrene-anhydrous maleate ester copolymer and mixtures thereof.

### The Dispersant

The additive package comprises at least one dispersant. More than one dispersant may be present in the additive package.

Because engine oils in hybrid internal combustion engines may not reach the same high temperatures experienced by engine oils in conventional internal combustion engines, high levels of water and fuel dilution in the engine oil may occur. Such water and fuel dilution can result in the formation of sludge in the engine oil.

Thus, the presence of at least one dispersant in the additive package may beneficially prevent or mitigate the effects of sludge formation in the engine oil composition employed in the method of the present invention.

The additive package comprises at least one dispersant in an amount to provide a total concentration of dispersant, excluding solvent and diluent (if present), in the engine oil composition of preferably 0.5 to 5% by weight based upon the engine oil composition, more preferably 2.0 to 4.0% by weight based upon of the engine oil composition.

Preferably, the at least one dispersant in the additive package is an ashless dispersant. Preferably, the at least one dispersant in the additive package is a non-borated dispersant.

Preferably, the dispersant is a reaction product of a carboxylic acylating agent (for example an acid or an anhydride) and (a) a nitrogen compound, for example an amine, typically a polyamine (for example diethylene triamine, triethylene tetramine, tetraethylene pentamine and higher ethylene amines) or (b) an organic hydroxyl compound (including for example, monohydric and polyhydric alcohols). The reaction product may comprise an imide, amide and/or ester reaction product of an organic hydroxyl compound.

The dispersant may be one or more dispersants produced by a Mannich reaction.

Suitable dispersants may be selected from the group consisting of imide succinates, amide succinates, benzyl amine, succinic esters, ester amide succinates and mixtures thereof. Suitable imide succinates may be selected from the group consisting of polyalkenyl imide succinates, for example polyisobutene succinimides.

The additive package may comprise a mixture of different types of dispersant.

### The Detergent

The additive package comprises at least one detergent. Preferably, the additive package comprises more than one detergent. The additive package comprises at least one detergent in an amount to provide a total concentration of detergent, excluding solvent and diluent (if present), in the engine oil composition preferably of 0.1 to 5% by weight based upon the engine oil composition, more preferably of 0.1 to 2.0% by weight based upon of the engine oil composition.

The at least one detergent may be selected from the group consisting of sulphonate detergents, salicylate detergents, phenate detergents and mixtures thereof. Suitable detergents include Lubrizol's 6477C, 6473, 6499 and 6490 and Infineum's C9371 and C9372.

### The Phosphorus-Containing, Anti-Wear Additive

The additive package comprises at least one phosphorus-containing, anti-wear additive in an amount to provide a total concentration of phosphorus-containing, anti-wear additives in the engine oil composition corresponding to 0.01 to 0.2 weight % phosphorus in the engine oil composition. The phosphorus-containing, anti-wear additive may be represented by the formula I:

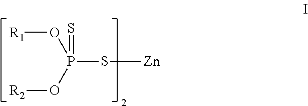

wherein R₁ and R₂ independently represent C₁₋₂₀ hydrocarbon groups. Examples of such C₁₋₂₀ hydrocarbon groups include C₁₋₂₀ alkyl groups, C₂₋₂₀ alkenyl groups, C₆₋₂₀ cycloalkyl groups, aryl groups, alkylaryl groups, arylalkyl groups and the like. The at least one phosphorus-containing, anti-wear additive is preferably, at least one zinc dialkyl dithiophosphate. Alkyl groups may include either or both of primary and secondary alkyl groups. The alkyl groups may be independently selected from the group of alkyl groups consisting of isopropyl groups, isobutyl groups, secondary butyl groups, pentyl groups, hexyl groups, 4-methyl-2-pentyl groups, octyl groups, 2-ethylhexyl groups, nonyl groups, decyl groups, dodecyl groups, tridecyl groups, tetradecyl groups, hexadecyl groups and octadecyl groups. The additive package may comprise at least one phosphorus-containing, anti-wear additive selected from the group consisting of zinc diisopropyl dithiophosphate, zinc diisobutyl dithiophosphate, zinc di secondary butyl dithiophosphate, zinc di(n-pentyl) dithiophosphate, zinc di(n-hexyl) dithiophosphate, zinc di(4-methyl-2-pentyl) dithiophosphate, zinc di(n-octyl) dithiophosphate, zinc di(2-ethylhexyl) dithiophosphate, zinc di(n-nonyl) dithiophosphate, zinc di(n-decyl) dithiophosphate, zinc di(n-dodecyl) dithiophosphate, zinc di(n-tridecyl) dithiophosphate, zinc di(n-tetradecyl) dithiophosphate, zinc di(n-hexadecyl) dithiophosphate, zinc di(n-octadecyl) dithiophosphate and mixtures thereof.

Suitable phosphorus-containing, anti-wear additive include Lubrizol's 1371 and Infineum's C9417.

### The Friction Modifier

The additive package may further comprise at least one friction modifier. Suitable friction modifiers may be selected from the group consisting of molybdenum dithiocarbamates, oleyl amides, glycerol monooleates, fatty acids, higher alcohols, fatty acid esters, fat and oil, amines, polyamides, sulphurised esters, phosphoric esters, acid phosphoric esters, phosphorus esters, phosphoric ester amine salts and mixtures thereof.

The additive package may comprise at least one friction modifier in an amount to provide a total friction modifier concentration in the engine oil composition of 0.05 to 5% by weight based on the engine oil composition.

Molybdenum dithiocarbamates may be present in the additive package in an amount to provide a total molybdenum concentration of 20 to 800 ppm by weight in the engine oil composition. Oleyl amide friction modifiers may be present in the additive package in an amount to provide a total concentration of 0.05 to 0.5% by weight in the engine oil composition. Glycerol monooleate friction modifiers may be present in the additive package in an amount to provide a total concentration of 0.05 to 0.5% by weight in the engine oil composition.

Suitable friction modifiers include glycerol monooleate, Sakuralube S100 and S160 and Crodamide O.

### Other Components in the Additive Package

The additive package may also comprise at least one antioxidant. The additive package may comprise at least one antioxidant in an amount to provide to the engine oil composition a total concentration of antioxidants of 0.05 to 5% by weight based upon the engine oil composition. Suitable antioxidants may be selected from the group consisting of phenolic antioxidants, amine-based antioxidants and mixtures thereof. Suitable antioxidants include Irganox L-135, and L-57 and Lubrizol's 5150C.

The engine oil of the present invention may be made by blending together the base oil and additive package in one or more steps.

The additive package may be made by blending together the components in one or more steps.

The additive package may be added to the base oil as one or more part-packs.

### The Hybrid Internal Combustion Engine

The hybrid internal combustion engine is used with one or more other sources of power in a hybrid vehicle and may be a spark ignition engine or a compression ignition engine. The combustible fuel may be hydrogen or a normally liquid fuel. The normally liquid fuel may be a gasoline fuel or a diesel fuel. The fuel may comprise biocomponents.

The hybrid internal combustion engine is operated with an engine oil temperature which is maintained below 123° C. Preferably, the temperature of the engine composition is maintained below 100° C.

The hybrid internal combustion engine may be operated with an engine oil temperature, for example, in the range of 80-90° C.

It will be understood that the engine oil temperature is the temperature of the bulk or majority of the engine oil. A suitable place in the engine to measure the temperature of the engine oil is at the oil gallery inlet of the engine which provides a suitable measure of the temperature of the bulk or majority of the engine oil.

The engine oil of the present invention may lubricate the engine by lubricating, in addition to the big end conrod bearing shells, at least the piston rings/cylinder liners, the main crankshaft bearings, the small end conrod bearing shells, the dynamic valve mechanisms and other sliding parts of the engine.

The hybrid internal combustion engine of the present invention may be used in a vehicle in series or in parallel with other power sources. Suitable other power sources include one or more of electric motors, hydraulic motors, inertia devices (for example flywheels) and the like.

The hybrid internal combustion engine may be used in series with an electrical generator. In use, electricity from the generator is fed to one or more motors that move the vehicle, and excess energy can be used to charge batteries. When large amounts of power are required, electricity comes from both the batteries and the engine-generator section.

The hybrid internal combustion engine may be used in parallel with an electric motor, both being connected to a mechanical transmission. In use, the internal combustion engine may be the dominant portion being used for primary power, with the electric motor turning on only when a boost is needed. Other systems can operate with just the electric motor or internal combustion engine operating alone.

In the another type of parallel system, the hybrid internal combustion engine may drive the wheels directly, with the electric motor serving as a power assist when extra power is needed, and to recapture the kinetic energy usually lost during braking.

The present invention will now be described with reference to the following example and FIGURE.

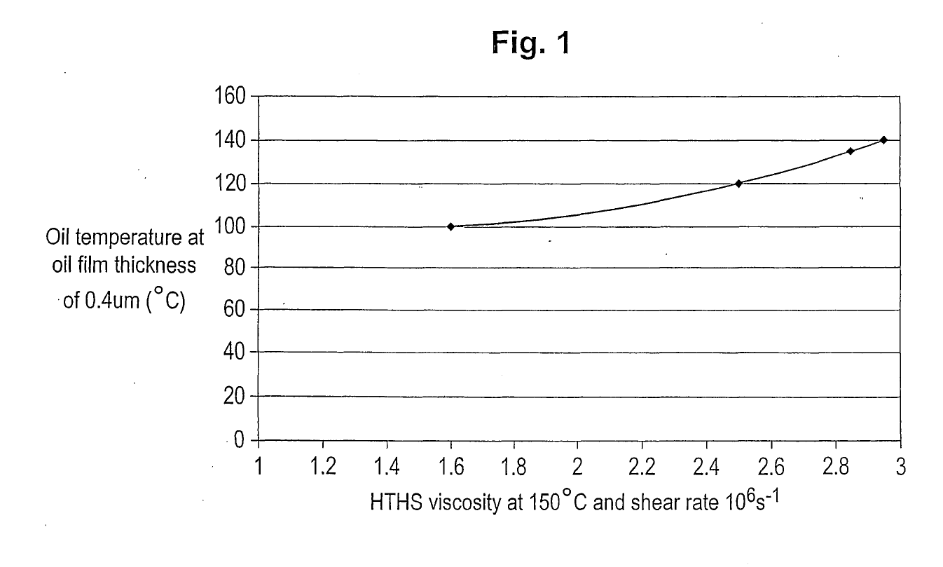

FIG. 1 is a graph showing the dependence of minimum oil film thickness in a big end conrod bearing shell of a light duty diesel engine on viscosity and temperature.

### EXAMPLE 1

A computer model (AVL Excite Designer Crank-Train Analysis) which simulates oil film thickness in crank-train bearings by computation of the hydrodynamic behaviour of cylindrical slider bearings under dynamic load (based on Butenschoens theory), was employed to determine the maximum oil temperature at which a minimum oil film thickness of 0.4 μm can be maintained in a big end conrod bearing shell of a light duty diesel engine operated at 1000 rpm for a series of engine oils having HTHS viscosities of 1.6, 2.5, 2.85 and 2.95 cP at 150° C. and a shear rate of 10⁶s⁻¹ respectively. The results are shown in graph form in FIG. 1.

The results from the computer model demonstrate that engine oil compositions having a HTHS viscosity of less than 2.6 cP at 150° C. and a shear rate of 10⁶s⁻¹ may not be usefully employed in conventional gasoline and diesel engines since in such engines the engine oil can reach temperatures exceeding the temperature at which the oil film thickness of such an oil in the big end conrod bearing shells would fall below 0.4 μm.

These results further demonstrate that oils having a HTHS viscosity of less than 2.6 cP at 150° C. and a shear rate of 10⁶s⁻¹ could be usefully employed in hybrid internal combustion engines wherein the temperature of the engine oil may be maintained such that the oil film thickness in the big end conrod bearing shell remains at least 0.4 μm.

### EXAMPLE 2

A engine oil composition consisting of: 90.25% by weight (based on the total weight of the engine oil composition) of a Group III synthetic base oil, which base oil was a mixture of a base oil having a kinematic viscosity of 4.24 cSt at 100° C. and a base oil having a kinematic viscosity of 6.45 cSt at 100° C., and 9.75% by weight of an additive package, consisting of PIB succinimide dispersant, metallic detergents, secondary ZDDP antiwear additive, ashless antioxidants and pour point depressant, and having a high temperature, high shear viscosity of 1.9 cP at 150° C. and a shear rate of 10⁶s⁻¹, a Noack volatility of 11.7 weight % and a total concentration of phosphorous of 737 ppm was used to lubricate a Ford Escape SUV hybrid internal combustion engine operated under a severe city drive cycle for 10000 miles. Acceptable operation of the engine and good fuel economy were observed.

1.-11. (canceled)

12. A method of operating an internal combustion engine, which method comprises:
fuelling said engine with a combustible fuel and lubricating said engine with an engine oil composition in which the engine oil composition has: a high temperature, high shear viscosity of less than 2.6 cP (2.6 millipascal second) at 150° C. and at a shear rate of 10⁶ S⁻¹; a Noack volatility of at most 13 weight %; and comprises: (A) a base oil which is at least one synthetic basestock, the base oil having a kinematic viscosity of at least 2.0 cSt (2.0 mm²/s) at 100° C.; and (B) an additive package which comprises at least one dispersant, at least one detergent, and at least one phosphorus-containing, anti-wear additive in an amount to provide a total concentration of phosphorus-containing, anti-wear additives in the engine oil composition corresponding to 0.01 to 0.2 weight % phosphorus in the engine oil composition characterised in that the engine is a hybrid engine, the temperature of the engine oil composition is maintained below 123° C.; and there is maintained an oil film thickness of the engine oil composition in the big end conrod bearing shells of the engine of at least 0.4 μm.

13. A method according to claim 12 wherein the temperature of the engine oil composition is in the range of 80-90° C.

14. A method according to claim 12 wherein the engine oil is an SAE grade OW, 5W, 10W, 0W20, 5W20 or 10W20 oil.

15. A method according to claim 13 wherein the engine oil is an SAE grade OW, SW, 10W, 0W20, 5W20 or 10W20 oil.

16. A method according to claim 12 wherein the base oil is selected from the group consisting of Group III basestocks; esters; basestocks derived from a gas to liquids process; basestocks derived from a pyrolysis process; basestocks derived from an asphalt to liquids process; polyalpha olefins; and mixtures thereof.

17. A method according to claim 13 wherein the base oil is selected from the group consisting of Group III basestocks; esters; basestocks derived from a gas to liquids process; basestocks derived from a pyrolysis process; basestocks derived from an asphalt to liquids process; polyalpha olefins; and mixtures thereof.

18. A method according to claim 14 wherein the base oil is selected from the group consisting of Group III basestocks; esters; basestocks derived from a gas to liquids process; basestocks derived from a pyrolysis process; basestocks derived from an asphalt to liquids process; polyalpha olefins; and mixtures thereof.

19. A method according to claim 15 wherein the base oil is selected from the group consisting of Group III basestocks; esters; basestocks derived from a gas to liquids process; basestocks derived from a pyrolysis process; basestocks derived from an asphalt to liquids process; polyalpha olefins; and mixtures thereof.

20. A method according to claim 12 wherein the additive package further comprises at least one viscosity modifier in an amount to provide a total concentration in the engine oil composition of viscosity modifiers of 0.1 to 10% by weight based upon the engine oil composition.

21. A method according to claim 18 wherein the additive package further comprises at least one viscosity modifier in an amount to provide a total concentration in the engine oil composition of viscosity modifiers of 0.1 to 10% by weight based upon the engine oil composition.

22. A method according to claim 12 wherein the additive package comprises at least one dispersant in an amount to provide a total concentration of dispersant, excluding solvent and diluent (if present), in the engine oil composition of 0.5 to 5% by weight based upon the engine oil composition.

23. A method according to claim 18 wherein the additive package comprises at least one dispersant in an amount to provide a total concentration of dispersant, excluding solvent and diluent (if present), in the engine oil composition of 0.5 to 5% by weight based upon the engine oil composition.

24. A method according to claim 12 wherein the additive package comprises at least one detergent in an amount to provide a total concentration of detergent, excluding solvent and diluent (if present), in the engine oil composition of 0.1 to 5% by weight based upon the engine oil composition.

25. A method according to claim 18 wherein the additive package comprises at least one detergent in an amount to provide a total concentration of detergent, excluding solvent and diluent (if present), in the engine oil composition of 0.1 to 5% by weight based upon the engine oil composition.

26. A method according to claim 12 wherein the additive package further comprises at least one friction modifier in an amount to provide a total friction modifier concentration in the engine oil composition of 0.05 to 5% by weight based on the engine oil composition.

27. A method according to claim 18 wherein the additive package further comprises at least one friction modifier in an amount to provide a total friction modifier concentration in the engine oil composition of 0.05 to 5% by weight based on the engine oil composition.

28. A method according to claim 12 wherein the additive package further comprises at least one antioxidant in an amount to provide to the engine oil composition a total concentration of antioxidants of 0.05 to 5% by weight based upon the engine oil composition.

29. A method according to claim 18 wherein the additive package further comprises at least one antioxidant in an amount to provide to the engine oil composition a total concentration of antioxidants of 0.05 to 5% by weight based upon the engine oil composition.

30. A method according to claim 12 wherein the additive package comprises:
at least one viscosity modifier in an amount to provide a total concentration in the engine oil composition of viscosity modifiers of 0.1 to 10% by weight based upon the engine oil;
at least one dispersant in an amount to provide a total concentration of dispersant, excluding solvent and diluent (if present), in the engine oil composition of 0.5 to 5% by weight based upon the engine oil composition;
at least one detergent in an amount to provide a total concentration of detergent, excluding solvent and diluent (if present), in the engine oil composition of 0.1 to 5% by weight based upon the engine oil composition;
at least one friction modifier in an amount to provide a total friction modifier concentration in the engine oil composition of 0.05 to 5% by weight based on the engine oil composition; and
at least one antioxidant in an amount to provide to the engine oil composition a total concentration of antioxidants of 0.05 to 5% by weight based upon the engine oil composition.

31. A method according to claim 18 wherein the additive package comprises:
at least one viscosity modifier in an amount to provide a total concentration in the engine oil composition of viscosity modifiers of 0.1 to 10% by weight based upon the engine oil;
at least one dispersant in an amount to provide a total concentration of dispersant, excluding solvent and diluent (if present), in the engine oil composition of 0.5 to 5% by weight based upon the engine oil composition;
at least one detergent in an amount to provide a total concentration of detergent, excluding solvent and diluent (if present), in the engine oil composition of 0.1 to 5% by weight based upon the engine oil composition;
at least one friction modifier in an amount to provide a total friction modifier concentration in the engine oil composition of 0.05 to 5% by weight based on the engine oil composition; and
at least one antioxidant in an amount to provide to the engine oil composition a total concentration of antioxidants of 0.05 to 5% by weight based upon the engine oil composition.

32. A method according to claim 12 wherein the hybrid engine is a spark ignition engine.

33. A method according to claim 13 wherein the hybrid engine is a spark ignition engine.

34. A method according to claim 12 wherein the hybrid engine is a compression ignition engine.

35. A method according to claim 13 wherein the hybrid engine is a compression ignition engine.
